(19) United States
(12) Patent Application Publication
(10) Pub. No.: US 2020/0363816 A1
(43) Pub. Date: Nov. 19, 2020

(54) SYSTEM AND METHOD FOR CONTROLLING AUTONOMOUS VEHICLES

(71) Applicant: WeRide Corp., Sunnyvale, CA (US)

(72) Inventors: Zhiyuan ZUO, Sunnyvale, CA (US); Albert WU, Sunnyvale, CA (US); Qiu JIN, Sunnyvale, CA (US); Tianming LU, Sunnyvale, CA (US); Zeyin ZHANG, Sunnyvale, CA (US); Xuanzhu LIN, Sunnyvale, CA (US); Xiong WU, Sunnyvale, CA (US); Yiqing YANG, Sunnyvale, CA (US); Hua ZHONG, Sunnyvale, CA (US); Zhilong LIU, Sunnyvale, CA (US)

(21) Appl. No.: 16/874,644

(22) Filed: May 14, 2020

Related U.S. Application Data
(60) Provisional application No. 62/848,602, filed on May 16, 2019.

(51) Int. Cl. G05D 1/02; B60W 50/00; B60W 40/105; B60W 40/11; B60W 40/107

(52) U.S. Cl. CPC G05D 1/0221; G05D 1/0219; B60W 50/0098; B60W 2050/0009; B60W 40/11; B60W 40/107; B60W 2050/0011; B60W 40/105

(57) ABSTRACT

A method for controlling a vehicle using a model predictive controller generating consecutive sets of reference states at a calculation frequency. In one embodiment, the method comprises: receiving a trajectory reference for guiding movement of the vehicle; generating, in a calculation cycle repeated at the calculation frequency, a set of reference states based on an initial state of the vehicle at a start time of the calculation cycle and the trajectory reference; sending the set of reference states to a second controller; detecting, by the second controller at a detection frequency equal to or higher than the calculation frequency, an updated state of the vehicle; generating a vehicle control parameter value based on the updated state of the vehicle and a reference state of the set of reference states; and controlling the vehicle using the vehicle control parameter value.

### TECHNICAL FIELD

The application generally relates to autonomous driving technologies, and in particular, the control of an autonomous vehicle.

### BACKGROUND

Autonomous driving is a challenging task that integrates many technologies. Three major components of an autonomous driving system are localization module (determine where is the vehicle), perception module (determine what is around the vehicle), and control module (determine how to drive around). Typically, an autonomous vehicle generates a target trajectory based on the output from the localization module and the perception module. The control module then outputs the vehicle's acceleration, brake and steering in order to follow the target trajectory.

Model predictive control (MPC) is an advanced method of process control that has been used in the autonomous driving control module. The main advantage of MPC is that it allows the current timeslot to be optimized while keeping future timeslots into account. This is achieved by optimizing a finite time-horizon, but only implementing the current timeslot and then optimizing again, repeatedly. Using MPC in an autonomous driving control module not only allows the vehicle to follow the target trajectory as close as possible but also as smooth as possible to avoid sudden steering or frequent braking. However, the input for an autonomous driving control module using MPC often includes noise of environmental disturbance and becomes not suitable for the path planning. Thus, there is a continued need for further improvement.

### SUMMARY

In a first aspect, the present disclosure provides a method for controlling a vehicle using a model predictive controller generating consecutive sets of reference states at a calculation frequency. In one embodiment, the method comprises: receiving a trajectory reference for guiding movement of the vehicle; generating, in a calculation cycle repeated at the calculation frequency, a set of reference states based on an initial state of the vehicle at a start time of the calculation cycle and the trajectory reference; sending the set of reference states to a second controller; detecting, by the second controller at a detection frequency equal to or higher than the calculation frequency, an updated state of the vehicle; generating a vehicle control parameter value based on the updated state of the vehicle and a reference state of the set of reference states; and controlling the vehicle using the vehicle control parameter value.

In another aspect, the present disclosure provides a device for controlling a vehicle.

The foregoing has outlined, rather broadly, features of the present application. Additional features of the present application will be described, hereinafter, which form the subject of the claims of the present application. It should be appreciated by those skilled in the art that the conception and specific embodiments disclosed herein may be readily utilized as a basis for modifying or designing other structures or processes for carrying out the objectives of the present application. It should also be realized by those skilled in the art that such equivalent constructions do not depart from the spirit and scope of the present application as set forth in the appended claims.

### BRIEF DESCRIPTION OF THE DRAWINGS

The aforementioned features and other features of the present application will be further described in the following paragraphs by referring to the accompanying drawings and the appended claims. It will be understood that, these accompanying drawings merely illustrate certain embodiments in accordance with the present application and should not be considered as limitation to the scope of the present application. Unless otherwise specified, the accompanying drawings need not be proportional, and similar reference characters generally denote similar elements.

FIG. 1 illustrates an exemplary autonomous driving system.

FIGS. 2A-2B illustrate an exemplary MPC controlling module.

FIG. 3 illustrate an exemplary controlling module of the present disclosure.

FIG. 4 shows an exemplary timing of reference states and updated states according to an embodiment.

FIGS. 5A and 5B show two vehicles that drive using the conventional MPC controlling module shown in FIGS. 2A and 2B and using the exemplary controlling module of the present disclosure shown in FIG. 3.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The present disclosure relates to methods and systems for controlling autonomous vehicles. For the sake of brevity, conventional techniques and components related to the autonomous driving technology and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

Autonomous Driving System

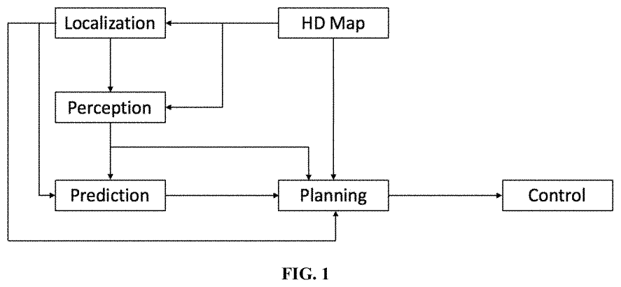

Autonomous vehicles (also known as driverless cars, self-driving cars or robot cars) are capable of sensing its environment and navigating without human input. Autonomous vehicle is a complex system integrating many technologies that coordinate to fulfill the challenging task of controlling a vehicle without human input. FIG. 1 illustrates an exemplary autonomous vehicle system that comprises functional subsystems, or modules, that work collaboratively to generate signals for controlling a vehicle.

Referring to FIG. 1, an autonomous vehicle system includes a high definition (HD) map that the autonomous vehicle can use to plan its path. A HD map used by an autonomous vehicle contains a huge amount of driving assistance information. The most important information is the accurate 3-dimensional representation of the road network, such as the layout of the intersection and location of signposts. The HD map also contains a lot of semantic information, such as what the color of traffic lights means, the speed limit of a lane and where a left turn begins. The major difference between the HD map and a traditional map is the precision—while a traditional map typically has a meter-level precision, the HD map requires a centimeter level precision in order to ensure the safety of an autonomous vehicle. The HD map dataset may be stored in the autonomous vehicle. Alternatively, the HD map dataset is stored and updated in a server (e.g., a cloud) that communicates with the autonomous vehicle and provides the map information necessary for the autonomous vehicle to use.

The information in the HD map is used by many other modules of the autonomous driving system. In the first place, a localization module depends on the HD map to determine the exact location of the autonomous vehicle. The HD map also helps a perception module to sense the environment around the autonomous vehicle when the surrounding area is out of the range of the sensors or blocked by an obstacle. The HD map also helps a planning module to find suitable driving space and to identify multiple driving routes. The HD map allows the planning module to accurately plan a path and choose the best maneuver.

A localization module of the autonomous driving system helps an autonomous vehicle to know where exactly it is, which is a challenging task because any single sensor or instrument currently available, such as GPS and IMU, is insufficient to provide location information accurately enough for autonomous driving. Current localization technology uses information gathered by the sensors installed in the autonomous vehicle to identify landmarks in the surrounding environment and determines the location of the autonomous vehicle relative to the landmarks. The localization module then compares the landmarks identified by the sensors to the corresponding landmarks in the HD map, thereby determining the exact location of the autonomous vehicle in the map. Typically, to ensure a localization of high precision required by autonomous driving, a localization module combines information collected by multiple sensors using different localization techniques, such as GNSS RTK (Global Navigation Satellite System Real-time Kinematics) used by GPS, inertial navigation used by IMU, LiDAR localization and visual localization.

A perception module of the autonomous driving system is configured to sense the surrounding of the autonomous vehicle using sensors such as camera, radar and LiDAR and to identify the objects around the autonomous vehicle. The sensor data generated by the sensors are interpreted by the perception module to perform different perception tasks, such as classification, detection, tracking and segmentation. Machine learning technologies, such as convolutional neural networks, have been used to interpret the sensor data. Technologies such as Kalman filter have been used to fuse the sensor data generated by different sensors for the purposes of accurate perception and interpretation.

Many of the objects around the autonomous vehicle are also moving. Therefore, a prediction module of the autonomous driving system is configured to predict the behavior of these moving objects in order for the autonomous vehicle to plan its path. Typically, the prediction module predicts the behavior of a moving object by generating a trajectory of the object. The collection of the trajectories of all the objects around the autonomous vehicle forms a prediction of a timestep. For each timestep, the prediction module recalculates the prediction for every moving object around the autonomous vehicle. These predictions inform the autonomous vehicle to determine its path.

A planning module of the autonomous driving system incorporates the data from the HD map module, localization module and prediction module to generates a trajectory for the vehicle. The first step of planning is route navigation that generates a navigable path. Once a high-level route is built, the planning module zooms into trajectory planning, which makes subtle decisions to avoid obstacles and creates a smooth ride for the passengers, i.e., to generate a collision-free and comfortable trajectory to execute.

The trajectory generated in the planning module is then executed by a control module to generate a series of control inputs including steering, acceleration and/or braking. Several conditions need be considered by the control module when generating control inputs. First, the controller needs to be accurate so that the result avoids deviation from the target trajectory, which is important for safety. Second, the control strategy should be feasible for the car. Third, comfortable driving is important for the passenger. Hence the actuation should be continuous and avoid sudden steering, acceleration or braking. In sum, the goal of the controlling module is to use viable control inputs to minimize deviation from the target trajectory and maximize passenger comfort.

Model Predictive Control

Model Predictive Control (MPC) is a process to minimize costs while satisfying a set of constraints. The main advantage of using MPC in controlling an autonomous vehicle is that it allows the current timeslot to be optimized while keeping future timeslots into account, which is achieved by optimizing a finite time-horizon, but only implementing the current timeslot and then optimizing again, repeatedly.

For example, an autonomous vehicle using MPC adjusts the steering and the speed every 100 milli-seconds (ms). The cost function is defined as the difference between the target trajectory point and the actual trajectory points of the vehicle. One constraint is that the wheel cannot be steered more than 25°, for example. The vehicle reads from the sensors to determine its current states such as speed. The autonomous driving system considers possible actions within a short period of time (e.g., 1 second) based on these readings. The controlling module using MPC determines that steering the wheel by 20° clockwise and then reduce it by 1° every 100 ms results in the lowest cost at the end of the one second period, the autonomous driving system will then apply the first action of steering the wheel 20°. But instead of performing the remaining actions later, the vehicle waits for 100 ms and read the sensors again. With the new readings, the controlling module re-computes the next optimal action again. In short, MPC makes the next action by taking advantaging of viewing the results of a longer future plan (1 sec). As a result, it is less vulnerable to short-sighted gain in a greedy method and therefore, plan better.

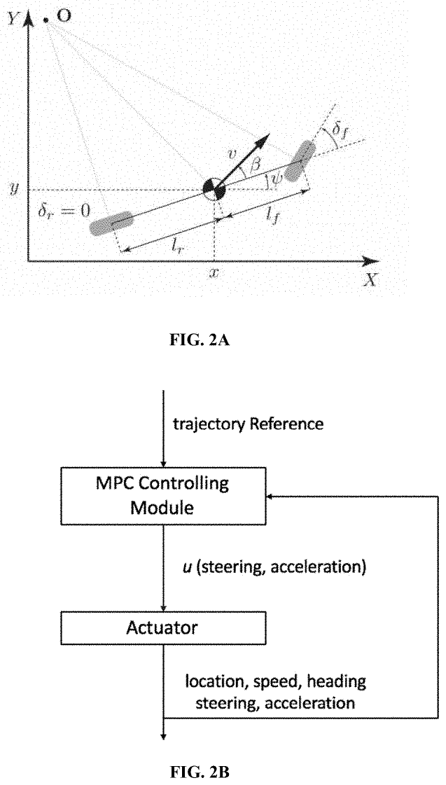

FIGS. 2A-2B illustrate an example of MPC controlling module for an autonomous driving system. Referring to FIG. 2A, MPC controlling module defines a kinematic model to describe the vehicle. (x, y) is the vehicle's center of mass. ψ is the current heading of the car and v is the speed of the vehicle. I_{f} is the distance from the center of the mass to the front axle. β is the angle of v with respect to the car axis. In this example, β is assumed to be zero (i.e. the car is not sliding). In this model, the vehicle is assumed to be a front-wheel-drive car, which can be controlled with the front wheel steering angle δ_{f} (for simplicity, written as δ) and the car acceleration a.

Referring to FIG. 2B, the MPC controlling module receives a trajectory reference, e.g., from a planning module. The trajectory can be in the form of 6 waypoints, i.e., 6 coordinates of (x, y). The 6 waypoints can be used to fit a model of 3^{rd} order polynomial function in order to compute they coordinate and the heading ψ from x as follows:

$$v = f ( x ) = {a}_{3} {x}^{3} + {a}_{2} {x}^{2} + {a}_{1} x + {a}_{0}$$

$$tan ( {ψ}_{dest} ) = \frac{d y}{dx} = 3 {a}_{3} {x}^{2} + 2 {a}_{2} x + {a}_{1} x$$

At each period (e.g., 100 ms), the MPC controlling module receives from the sensors to determine the current state of the vehicle including: location of the vehicle (x, y), speed v, heading ψ, the steering angle δ, and the acceleration a.

Next, the MPC controlling module creates a dynamic model for predicting the state at time t+1 of the vehicle from the last state at time t. Using the kinematic model, the MPC controlling module can deduce the location, the heading and the speed from the last state as follows:

$${x}_{t + 1} = {x}_{t} + {v}_{t} cos ( {ψ}_{t} ) d t$$

$${y}_{t + 1} = {γ}_{t} + {v}_{t} sin ( {ψ}_{t} ) d t$$

$${ψ}_{t + 1} = {ψ}_{t} + \frac{{v}_{t}}{{l}_{f}} {δ}_{t} dt$$

$${v}_{t + 1} = {v}_{t} + {a}_{t} d t$$

The MPC module may also add 2 more states to measure the cross-track error (cte) and the heading error for ψ (eψ).

$$c t {e}_{t + 1} = f ( {x}_{t} ) - {y}_{t} + {v}_{t} sin ( e {ψ}_{t} ) dt$$

$$e {ψ}_{t + 1} = {ψ}_{ζ} + ψ {des}_{t} \frac{{v}_{t}}{{l}_{f}} {δ}_{t} dt$$

In this example, the MPC module uses the dynamic model to compute the next 9 states (i.e., long time slot of 1 sec with 10 short time slots of 100 ms).

The MPC controlling module further defines a cost function to optimize the path with the trajectory. The cost includes: cross-track error, heading error, speed cost (e.g. prefer staying at 100 miles/hr), steering cost (prefer zero steering), acceleration cost (prefer zero acceleration), steering rate change (prefer small values), acceleration rate change (prefer small values).

Since those objectives may be contradictory to others, the cost function adds weights to the cost to reflect its priority as follows:

J=Σₜ₌₁^{N}(w_{cte}∥cteₜ∥²+w_{eψ}∥eψₜ∥²+wᵥ∥vₜ−v_{target}∥²)+Σₜ₌₁^{N-1}(w_{δ}∥δₜ∥²+wₐ∥aₜ∥²)+Σₜ₌₂^{N}(wᵣₐₜₑ_{_{δ}}∥δₜ−δₜ₋₁∥²+wᵣₐₜₑ_{ₐ}∥aₜ−aₜ₋₁∥²)

The MPC controlling module also defines the constraints for the cost function, e.g., δϵ[−25°,25°], aϵ[−1,1]. It can be appreciated that the two constraints are modeled into the MPC kinematic model as an example. In other embodiments, some other constraints such as wind speed, road condition, weather, etc. may also be modeled into the MPC kinematic model, which may then be considered during the calculation of the MPC states. However, the modeling of constraints cannot be implemented in real-time which may cause issues discussed below.

The MPC controlling module then uses the cost function to find the best actions for time period 1 to time period 10 that have the minimum total cost under the defined constraints.

The MPC controlling module will only output the first control parameter value to the actuator and ignore the others. The MPC module then repeats the process described above by receiving an updated trajectory reference, e.g., an updated set of 6 waypoints.

### Exemplary Embodiments

The invention disclosed in the present application may be understood through the following exemplary embodiments and the accompanying drawings. Unless otherwise stated in the context, similar symbols generally represent similar components in the accompanying figures. The illustrative embodiments in the following detailed description, the accompanying drawings and the claims are not limiting, and other embodiments may be adopted, or modifications may be made without deviating from the spirit and subject of the application. It should be understood that, the various aspects of the application described and graphically presented herein may be arranged, replaced, combined, divided and designed in many different configurations, and these different configurations are implicitly included in the application.

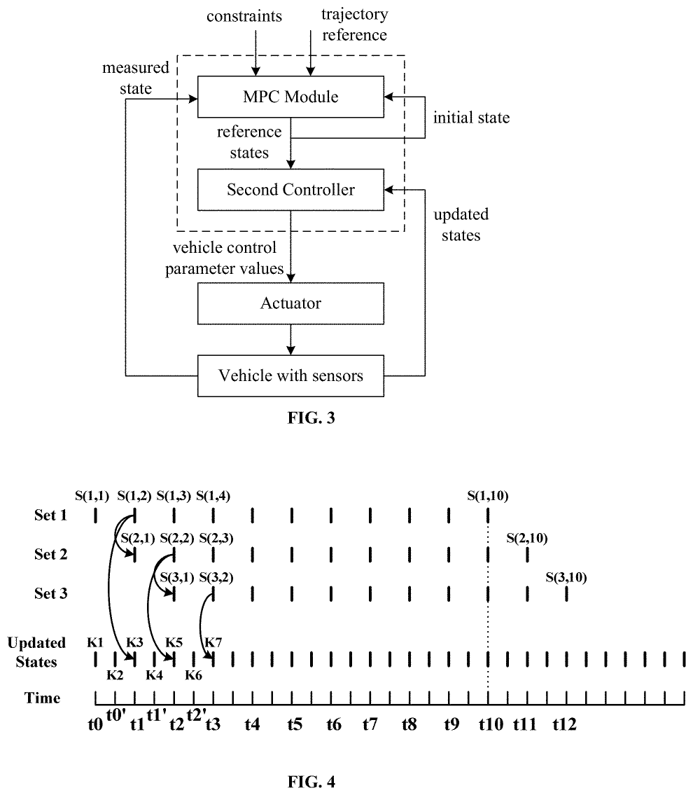

FIG. 3 illustrates an exemplary method for controlling an autonomous vehicle of the present disclosure. The method comprises sending one or more vehicle control parameter values to an actuator, i.e. a vehicle automated control device. In certain embodiments, the vehicle control parameter value is sent in about every 100 ms. The vehicle control parameter values apply to the actuator to change the driving of the vehicle.

In certain embodiments, the vehicle control parameter value is generated by a controlling module comprising an MPC module and a second controller. Referring to FIG. 3, the MPC module receives a trajectory reference, e.g., from a planning module. For example, the trajectory can be in the form of 6 waypoints, i.e., 6 coordinates of (x, y). The 6 waypoints can be used to fit a model of 3^{rd} order polynomial function in order to compute they coordinate and the heading ψ from x as follows:

$$y = f ( x ) = {a}_{3} {x}^{3} + {a}_{2} {x}^{2} + {a}_{1} x + {a}_{0}$$

$$tan ( {ψ}_{dest} ) = \frac{d y}{d x} = 3 {a}_{3} {x}^{2} + 2 {a}_{2} x + {a}_{1} x$$

The MPC module also receives inputs regarding the current state of the vehicle, including location of the vehicle (x, y), speed v, heading ψ, the steering angle δ, and the acceleration a. The current state of the vehicle can be used by the MPC module as an initial value or initial state, along with the trajectory reference, to generate certain number of reference states or estimated states of the vehicle over a predetermined future period starting from the initial state at a start time of the predetermined period. The inventors have surprisingly found that keeping using the inputs from the sensors (i.e. measured states of the vehicle which reflect actual movement of the vehicle) to determine the future reference states of the vehicle introduces unnecessary noise and disturbance from the environment.

As a result, in the method of the present disclosure, unlike a conventional MPC module as described above, not all inputs for the MPC module regarding the initial state of the vehicle are received from sensors of the vehicle. As the MPC module repeatedly generates reference states, a reference state previously generated, instead of the measured state from the sensors, can be selected and determined by the MPC module as an initial state for generating future reference states. In other words, the MPC module may not always take the actual measured state of vehicle into account during the generation of reference states, which effectively helps to filter excessive noises or interferences out of the MPC module. In certain embodiments, the MPC module may use a measured state of the vehicle as an initial state at an initialization stage, but use the reference states previously generated in calculation cycles as other initial states of the respective subsequent calculation cycles after the initialization stage. That is to say, as long as the state estimation of the vehicle is initialized by the MPC module, the actual states of the vehicle may not be needed in generation of the reference states. It can be appreciated that, in certain embodiments, the MPC module may repeat the initialization at a relatively low frequency, for example, every time when the autonomous driving engages after human driving, such that the MPC module can update the actual state of the vehicle from the sensors at such low frequency.

It can be seen that, if the MPC module reduces using inputs from the sensors for reference state generation or estimation, the actual state of the vehicle cannot be accurately tracked. In order to address that issue, the second controller may keep receiving updated states of the vehicle from the sensors and the reference states from the MPC module, and use these updated states and reference states to generate one or more vehicle control parameter values. The second controller may be a model-less controller which does not implement complicated model prediction algorithm. This helps to improve the latency of generating the vehicle control parameters values. Moreover, such feedback control by the model-less second controller further resolves a potential issue in the conventional MPC modules that certain aspect(s), especially some suddenly changing aspects, of the actual environment and road condition for the vehicle may not be timely modelled as constraints into the MPC model, which will be elaborated in the following with more details.

In an embodiment, the MPC module may generate sets of reference states based on the trajectory reference and respective initial states at a calculation frequency. For example, the MPC module uses a dynamic model to predict a reference state at time t+1 of the vehicle from an initial state which may be the last reference state at time t. For example, using the kinematic model, the MPC module can deduce the location, the heading, the speed, the cross-track error (cte) and the heading error for ψ (eψ) from the last state as follows:

$${x}_{t + 1} = {x}_{t} + {v}_{t} cos ( {ψ}_{t} ) d t$$

$${y}_{t + 1} = {y}_{t} + {v}_{t} sin ( {ψ}_{t} ) d t$$

$${ψ}_{t + 1} = {ψ}_{t} + \frac{{ν}_{t}}{{l}_{f}} {δ}_{t} d t$$

$${v}_{t + 1} = {v}_{t} + {a}_{t} d t$$

$${cte}_{t + 1} = f ( {x}_{t} ) - {y}_{t} + {v}_{t} sin ( e {ψ}_{t} ) d t$$

$$e {ψ}_{t + 1} = {ψ}_{t} + ψ d e {s}_{t} \frac{{ν}_{t}}{{l}_{f}} {δ}_{r} dt$$

In one example, the MPC module uses the dynamic model to compute the next 9 reference states (i.e., long time slot of 1 sec with 10 short time slots of 100 ms) over a predetermined period. The predetermined period may be longer than the calculation cycle, and thus some reference states may be redundant, which will be elaborated below.

Specifically, the MPC module uses a cost function to optimize the path with the trajectory. In one example, the cost function can be as follows:

J=Σₜ₌₁^{N}(w_{cte}∥cteₜ∥²+w_{eψ}∥eψₜ∥²+wᵥ∥vₜ−v_{target}∥²)+Σₜ₌₁^{N-1}(w_{δ}∥δₜ∥²+wₐ∥aₜ∥²)+Σₜ₌₂^{N}(wᵣₐₜₑ_{_{δ}}∥δₜ−δₜ₋₁∥²+wᵣₐₜₑ_{ₐ}∥aₜ−aₜ₋₁∥²)

And the constraints for the cost function can be defined as δϵ[−25°,25°], aϵ[−1,1]. As aforementioned, the constraints used in MPC model may vary depending on the actual environment and road condition for the vehicle. In this way, the changes in the actual environment and road condition such as a sudden car on the road can be reflected in the calculation of reference states to avoid unnecessary safety issues. The constraints may also reflect the driving performance of the vehicle. In the embodiment, the constraints can also be input into the MPC module. Alternatively, a portion or all of the constraints may be stored in the MPC module. It should be noted that modeling and updating actual environment and road conditions as one or more constraints may take time and not be implemented immediately upon the environment and road conditions change.

In some embodiments, the initial state input to the kinematic model can also be obtained in other manners. For example, one or more reference states previously generated reflect the movement of the vehicle at one or more previous times, thus these previous reference states can be used to deduce a state used as the initial state for future reference state generation, for example, by way of interpolating the initial state between two previous reference states. In other words, the initial state may not need to be aligned with any of the previous reference states in time.

After using the cost function to find the best actions for time period 1 to time period 10 that have the minimum total cost under the defined constraints, the MPC module outputs a set of reference states to the second controller.

In preferred embodiments, the second controller is a model-less controller capable of resisting environmental or system disturbance, such as proportional-and-derivative (PD) controller or proportional-integral-and-derivative (PID) controller plus disturbance observer, whether such environmental or system disturbance has or has not been modelled as constraints for the MPC module.

The second controller receives the set of reference states and multiple updated states which are detected by the sensors at a detection frequency other than the calculation frequency. In some embodiments, the second controller further aligns the reference states and the updated states in time, and outputs, based on each pair of aligned reference state and updated state, one or more vehicle control parameter values including, e.g. steering angle and acceleration etc. to an actuator to control the vehicle. The updated states are measurement results from the sensors which can be acquired or updated at a higher frequency. For example, the second controller may determine by comparison a difference between the reference state and the updated state and generate vehicle control parameter values that tend to mitigate such difference. As such, the actual movement of the vehicle may follow and track the ideal movement or trajectory of the vehicle. In some alternative embodiments, the second controller may not need to align the reference states with updated states respectively. For example, the second controller may generate an actual trajectory (e.g. by curve fitting) based on the updated states detected, and compare each reference state with the actual trajectory to generate respective vehicle control parameter values. It would be readily appreciated that the second controller can use any other suitable state feedback and control algorithms for generating the vehicle control parameter values.

In some embodiments, the detection frequency is equal to or higher than the calculation frequency. It can be appreciated that, since the MPC module may generate abundant reference states, the second controller may use the latest reference state generated for comparison with the updated state acquired.

FIG. 4 shows an exemplary timing of reference states and updated states according to an embodiment.

As shown in FIG. 4, the MPC module may initialize by receiving a measured state of the vehicle at time t0 and use it as a first initial state S(1,1). Then the MPC module may generate a first set of reference states S(1,2) to S(1,10) which are distributed over a predetermined time period t0-t10. In some embodiments, the set of reference states may be uniformly distributed over the period t0-t10, as is shown in FIG. 4. In some other embodiments, the set of reference states may not be uniformly distributed. For example, the earlier reference states may have relatively denser intervals while the later reference states may have relatively looser intervals. Afterwards, the MPC module may repeat the calculation of reference states. Specifically, the MPC module may use the reference state S(1,2) as a second initial state S(2,1) at time t1 which is one calculation cycle later than time t0, and generate a second set of reference states S(2,2) to S(2,10). The second initial state S(2,1) may be at a start time of the calculation cycle, and thus each reference state of the second set may be one calculation cycle later than respective ones of the first set of reference states. Similarly, the MPC module may use the reference state S(2,2) as a third initial state S(3,1) at time t2 which is two calculation cycles later than time t0, and generate a third set of reference states S(3,2) to S(3,10).

Furthermore, multiple updated states may be detected by the sensors of the vehicle, including updated state K1 at time t0, updated state K3 at time t1, updated state K5 at time t2 and updated state K7 at time t3 and so on. In the example, the detection frequency is twice the calculation frequency, and thus at the start time of each calculation cycle there is an updated state. The updated state can be compared to the corresponding reference state to generate vehicle control parameter values that tend to mitigate the difference therebetween. It should be noted that although the reference states are shown in FIG. 4 at discrete time points (e.g. t0, t1, t2 . . . ), each reference state may contain an estimated or expected state of the vehicle over a subsequent time period. For example, the reference state S(2,1) may include how the state of the vehicle is expected to change over the time period from t1 to t2. In this way, even if the updated states may be generated at a higher frequency than the reference state, such updated states can all be compared to the reference states. For example, the reference state S(1,2) may have information sufficient for comparison with updated states K3 and K4 respectively at times t1 and t1′. Accordingly, the second controller may generate vehicle control parameter values at a frequency substantially the same as the detection frequency of the updated states, and thus can track the state change of the vehicle more closely.

At time t0, the initial state S(1,1) is a measured state which should be the same as the updated state, so the second controller may not need to generate vehicle control parameter values at time t0. At time t1, the reference state S(1,2) in Set 1 and the initial state S(2,1) are the same and thus the reference state S(1, 2) may be sent to the second controller for generating one or more vehicle control parameter values at time t1. It can be appreciated that the first set of reference states may be generated some time after time t1, and the latency depends on the complexity of the MPC process and the capability/performance of the MPC module. The calculation cycle may be determined longer than the latency.

It can be seen that, two sets of reference states overlap in time. Except times t0 and t1, two or more reference states are generated. For example, at time t2, reference state S(1,3) in Set 1 and reference state S(2,2) in Set 2 are generated. Thus, the latest reference states at times t2, t3, etc., i.e. reference states S(2,2), S(3,2), etc. may be sent to the second controller for generating the respective vehicle control parameter values at times t2, t3, etc. The reason for the redundancy of reference states is that each set of reference states covers a predetermined period longer than the calculation cycle. The redundancy of reference states also improves the robustness and reliability of the method.

It can be appreciated that FIG. 4 is only to exemplarily illustrate how an embodiment of the method operates, and modifications and changes can be made to the embodiment shown in FIG. 4 or any other embodiments of the present application according to different circumstances and requirements. In another embodiment, each initial state of a set of reference states may not be aligned in time with any reference state in its previous set. For example, the initial state S(3,1) in Set 3 may be delayed by half of a calculation cycle to between time t2 and time t3 shown in FIG. 4. In that case, an interpolated state between reference state S(2,2) and reference state S(2,3) can be used as the initial state for Set 3, and accordingly, the reference states in Set 3 may not be aligned with times 3 to t12 as shown in FIG. 4.

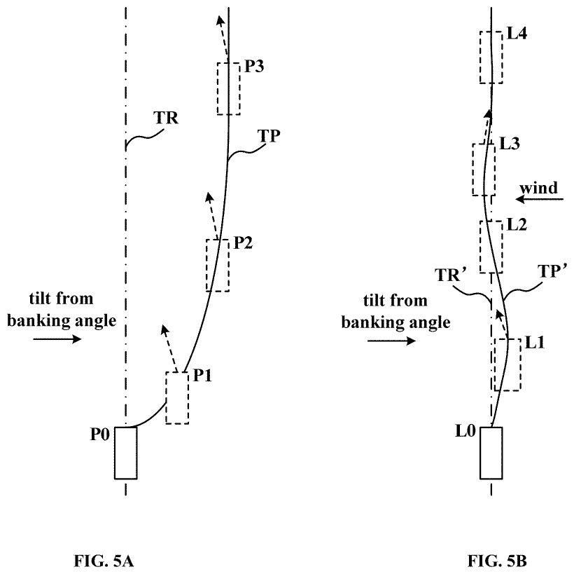

FIGS. 5A and 5B show two vehicles that drive using the conventional MPC controlling module shown in FIGS. 2A and 2B and using the exemplary controlling module of the present disclosure shown in FIG. 3.

As shown in FIG. 5A, a planning module may generate a trajectory reference TR starting from position P0 which the vehicle is expected to follow over a future time period. The conventional MPC controlling module shown in FIGS. 2A and 2B can then calculate the reference states of the vehicle using a MPC model with defined constraints and control the actuator of the vehicle to drive accordingly. However, since position P1, a surface of the road on which the vehicle is driving may have a banking angle with respect to the horizontal plane, which may tilt the vehicle towards a right roadside as indicated in FIG. 5A. However, such banking angle may not be considered in the MPC model initially modeled when the vehicle is at position P0 and thus is not a constraint used in the MPC controlling model. In order to resist the influence of the banking angle, the MPC controlling model may adjust or generate the vehicle control parameter values accordingly after the vehicle passes position P1. For example, a steering angle towards leftward may be provided to the vehicle to balance a rightward element of a supporting force (to resist the gravity) caused from the banking angle. However, the adjusted vehicle control parameter values cannot drive the vehicle back onto the trajectory reference TR, but simply drive it along an actual path TP which may be parallel with but spaced away from the trajectory reference TR after the vehicle passes position P3. Also, the distance from the actual path TP to the trajectory reference TR increases when the vehicle drives from position P1 to position P3. It can be seen that such deviation from the trajectory reference TR is caused from the non-real-time modeling of constraints in the MPC model.

In contrast, as shown in FIG. 5B, the MPC module according to the embodiment of the present disclosure can generate a set of reference states based on an initial state of the vehicle at position L0 and a trajectory reference TR′ input thereto, and later generate periodically other sets of reference states according to the embodiment shown in FIG. 3. The generated reference states should be consistent with the trajectory reference TR′, because the MPC module may not use the updated states detected by the vehicle sensors in real time, except for the initialization step. Similarly, the road surface may have a non-modeled constraint which is a banking angle since position L1. And the rightward tilt of the vehicle caused from the banking angle of the road surface may be detected by the vehicle sensors and included in the updated states, which may further affect the vehicle control parameter values generated by the second controller. In this way, the actual path TP′ along which the vehicle may drive on the road may shortly return back to the trajectory reference TR′ or may slightly sway about the trajectory reference TR′ due some other sudden changes in environment or road conditions (e.g. a wind), even if the banking angle or the wind is not modelled as a constraint of the MPC model used in the MPC module. It can be seen that, the second controller effectively mitigates the influence of the changing road conditions and desirably keeps, in coordination with the MPC model, the vehicle to drive as planned.

It should be noted that, the device and methods disclosed in the embodiments of the present disclosure can be implemented by other ways. The aforementioned device and method embodiments are merely illustrative. For example, flow charts and block diagrams in the figures show the architecture and the function operation according to a plurality of devices, methods and computer program products disclosed in embodiments of the present disclosure. In this regard, each frame of the flow charts or the block diagrams may represent a module, a program segment, or portion of the program code. The module, the program segment, or the portion of the program code includes one or more executable instructions for implementing predetermined logical function. It should also be noted that in some alternative embodiments, the function described in the block can also occur in a different order as described from the figures. For example, two consecutive blocks may actually be executed substantially concurrently. Sometimes they may also be performed in reverse order, depending on the functionality. It should also be noted that, each block of the block diagrams and/or flow chart block and block combinations of the block diagrams and/or flow chart can be implemented by a dedicated hardware-based systems execute the predetermined function or operation or by a combination of a dedicated hardware and computer instructions.

If the functions are implemented in the form of software modules and sold or used as a standalone product, the functions can be stored in a computer readable storage medium. Based on this understanding, the technical nature of the present disclosure, part contributing to the prior art, or part of the technical solutions may be embodied in the form of a software product. The computer software product is stored in a storage medium, including several instructions to instruct a computer device (may be a personal computer, server, or network equipment) to perform all or part of the steps of various embodiments of the present. The aforementioned storage media include: U disk, removable hard disk, read only memory (ROM), a random access memory (RAM), floppy disk or CD-ROM, which can store a variety of program codes.

Various embodiments have been described herein with reference to the accompanying drawings. It will, however, be evident that various modifications and changes may be made thereto, and additional embodiments may be implemented, without departing from the broader scope of the invention as set forth in the claims that follow.

Those skilled in the art may understand and implement other variations to the disclosed embodiments from a study of the drawings, the disclosure, and the appended claims. In the claims, the word “comprising” does not exclude other elements or steps, and the indefinite article “a” or “an” does not exclude a plurality. In applications according to present application, one element may perform functions of several technical feature recited in claims. Any reference signs in the claims should not be construed as limiting the scope. The scope and spirit of the present application is defined by the appended claims.

What is claimed is:

1. A method for controlling a vehicle using a model predictive controller that generates consecutive sets of reference states at a calculation frequency, the method comprising:
receiving a trajectory reference for guiding movement of the vehicle;
generating, in a calculation cycle repeated at the calculation frequency, a set of reference states based on an initial state of the vehicle at a start time of the calculation cycle and the trajectory reference;
sending the set of reference states to a second controller;
detecting, by the second controller at a detection frequency equal to or higher than the calculation frequency, an updated state of the vehicle;
generating a vehicle control parameter value based on the updated state of the vehicle and a reference state of the set of reference states; and
controlling the vehicle using the vehicle control parameter value.

2. The method of claim 1, wherein the initial state is a measured state of the vehicle when the vehicle is at initialization of the method.

3. The method of claim 1, wherein the initial state is a reference state generated in a previous calculation cycle when the vehicle is not at initialization of the method.

4. The method of claim 1, wherein the set of reference states overlap in time with a set of reference states generated in a previous calculation cycle.

5. The method of claim 1, wherein the set of reference states are uniformly distributed over a predetermined period.

6. The method of claim 1, wherein generating a vehicle control parameter value based on the updated state of the vehicle and a reference state of the set of reference states comprises:
aligning the reference state with the updated state in time.

7. The method of claim 1, wherein the set of reference states are generated by the model predictive controller by satisfying a varying set of constraints.

8. The method of claim 1, wherein the initial state comprises at least one of the following: location of the vehicle, speed of the vehicle, heading of the vehicle, steering angle of the vehicle, and acceleration of the vehicle.

9. The method of claim 1, wherein the reference state comprises at least one of the following: location of the vehicle, speed of the vehicle, heading of the vehicle, steering angle of the vehicle, and acceleration of the vehicle.

10. The method of claim 1, wherein the vehicle control parameter value comprises steering angle of the vehicle, throttle of the vehicle and brake of the vehicle.

11. The method of claim 1, wherein the trajectory reference is generated by a planning module.

12. The method of claim 1, wherein the location of the vehicle is generated by a localization module.

13. The method of claim 1, wherein the second controller is a model-less controller not based on model prediction.

14. The method of claim 13, wherein the model-less controller is a proportional-integral-derivative (PID) controller or a proportional-derivative (PD) controller.

15. A device for controlling a vehicle, the device comprising:
a processor; and
a memory for storing instructions executable by the processor;
wherein the processor is configured to perform a method for controlling a vehicle using a model predictive controller that generates consecutive sets of reference states at a calculation frequency, wherein the method comprises:
receiving a trajectory reference for guiding movement of the vehicle;
generating, in a calculation cycle repeated at the calculation frequency, a set of reference states based on an initial state of the vehicle at a start time of the calculation cycle and the trajectory reference;
sending the set of reference states to a second controller;
detecting, by the second controller at a detection frequency equal to or higher than the calculation frequency, an updated state of the vehicle;
generating a vehicle control parameter value based on the updated state of the vehicle and a reference state of the set of reference states; and
controlling the vehicle using the vehicle control parameter value.

16. A non-transitory computer-readable storage medium having stored therein instructions that, when executed by a processor, causes the processor to perform a method for controlling a vehicle using a model predictive controller that generates consecutive sets of reference states at a calculation frequency, wherein the method comprises:
receiving a trajectory reference for guiding movement of the vehicle;
generating, in a calculation cycle repeated at the calculation frequency, a set of reference states based on an initial state of the vehicle at a start time of the calculation cycle and the trajectory reference;
sending the set of reference states to a second controller;
detecting, by the second controller at a detection frequency equal to or higher than the calculation frequency, an updated state of the vehicle;
generating a vehicle control parameter value based on the updated state of the vehicle and a reference state of the set of reference states, wherein the reference state is aligned with the updated state in time; and
controlling the vehicle using the vehicle control parameter value.
